(19) United States
(12) Patent Application Publication
(10) Pub. No.: US 2008/0204371 A1
(43) Pub. Date: Aug. 28, 2008

(54) FILTER AND FLAT PANEL DISPLAY DEVICE USING THE FILTER

(75) Inventors: Hong Rae CHA, Seoul (KR); Ji Hoon SOHN, Seoul (KR); Sam Je CHO, Seoul (KR); Woo Sung JANG, Seoul (KR); Woon Seo SHIN, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/964,097

(22) Filed: Dec. 26, 2007

(30) Foreign Application Priority Data
Feb. 28, 2007 (KR) 10-2007-0020414

(51) Int. Cl. G09G 3/28

(52) U.S. Cl. 345/60

(57) ABSTRACT

A filter and a plasma display device using the filter are provided. The plasma display device includes a plasma display panel (PDP) which includes an upper substrate and a lower substrate that are coupled to each other; and a filter which is disposed on the upper substrate. The filter includes an external light shield sheet which includes a base unit and a plurality of pattern units that are formed in the base unit, and a distance between bottoms of a pair of adjacent electrodes that are formed on the upper substrate is 2.5-12 times greater than a distance between a pair of adjacent pattern units. Since the plasma display device includes the external light shielding sheet which can absorb and shield as much external light incident upon the PDP as possible, the plasma display device can effectively realize black images and enhance bright room contrast. Since the distance between the pair of adjacent pattern units of the external light shielding sheet is within a predetermined percentage range of the distance between a pair of adjacent black matrices formed on the PDP or the width of the pattern units of the external light shielding sheet is a predetermined percentage range of the width of black matrices formed on the PDP, the plasma display device can reduce the probability of occurrence of the moire phenomenon and enhance the luminance of images displayed by the PDP.

This application claims priority from Korean Patent Application No. 10-2007-0020414 filed on Feb. 28, 2007 in the Korean Intellectual Property Office, the disclosure of which is incorporated herein by reference in its entirety.

### BACKGROUND OF THE INVENTION

1. Field of the Invention

The present invention relates to a plasma display device, and more particularly, to a plasma display device in which an external light shield sheet for shielding external light incident upon a plasma display panel (PDP) is disposed at a front of the PDP so that the bright room contrast of the PDP can be improved, and that the luminance of the PDP can be uniformly maintained.

2. Description of the Related Art

In general, plasma display panels (PDPs) display images including text and graphic images by applying a predetermined voltage to a number of electrodes installed in a discharge space to cause a gas discharge and then exciting phosphors with the aid of plasma that is generated as a result of the gas discharge. PDPs are easy to manufacture as large-dimension, light, and thin flat displays. In addition, PDPs can provide wide vertical and horizontal viewing angles, full colors and high luminance.

In the meantime, external light incident upon a PDP may be reflected by an entire surface of the PDP due to white phosphors that are exposed on a lower substrate of the PDP. For this reason, PDPs may mistakenly recognize and realize black images as being brighter than they actually are, thereby causing contrast degradation.

### SUMMARY OF THE INVENTION

The present invention provides a plasma display device in which an external light shield sheet for shielding external light incident upon a plasma display panel (PDP) is disposed at a front of the PDP so that the bright room contrast of the PDP can be improved, and that the luminance of the PDP can be uniformly maintained.

According to an aspect of the present invention, there is provided a plasma display device, including a PDP which includes an upper substrate and a lower substrate that are coupled to each other; and a filter which is disposed on the upper substrate. The filter includes an external light shield sheet which includes a base unit and a plurality of pattern units that are formed in the base unit, and a distance between bottoms of a pair of adjacent electrodes that are formed on the upper substrate is 2.5-12 times greater than a distance between a pair of adjacent pattern units.

According to another aspect of the present invention, there is provided a plasma display device, including a PDP which includes an upper substrate and a lower substrate that are coupled to each other; and a filter which is disposed on the upper substrate. The filter includes an external light shield sheet which includes a base unit and a plurality of pattern units that are formed in the base unit, the lower substrate includes a plurality of electrodes and a plurality of horizontal barrier ribs which intersect the electrodes, and a distance between bottoms of a pair of adjacent horizontal barrier ribs is 6-20 times greater than a distance between a pair of adjacent pattern units.

According to another aspect of the present invention, there is provided a filter, including an external light shield sheet which includes a base unit and a plurality of pattern units that are formed in the base unit. A distance between bottoms of a pair of adjacent electrodes that are formed on an upper substrate of a display panel is 2.5-12 times greater than a distance between a pair of adjacent pattern units.

According to another aspect of the present invention, there is provided a filter, including an external light shield sheet which includes a base unit and a plurality of pattern units that are formed in the base unit. A distance between a pair of adjacent horizontal barrier ribs that are formed on a display panel is 6-20 times greater than a distance between bottoms of a pair of adjacent pattern units.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a plasma display panel (PDP) according to an embodiment of the present invention;

FIG. 2 is a cross-sectional view of an external light shield sheet that can be included in a filter according to an embodiment of the present invention;

FIG. 3 is a cross-sectional view for explaining a function of an external light shield sheet according to an embodiment of the present invention;

FIG. 4 is a cross-sectional view of a plurality of pattern units of an external light shield sheet according to an embodiment of the present invention;

FIGS. 5 and 6 are plan views of a plurality of pattern units of an external light shield sheet according to an embodiment of the present invention;

FIG. 7 is a plan view for explaining the structure of bus electrodes that are formed on an upper substrate of a PDP according to an embodiment of the present invention;

FIGS. 8 and 9 are plan views of various barrier rib structures that can be formed on an lower substrate of a PDP according to an embodiment of the present invention;

FIGS. 10 through 15 are cross-sectional views of external light shield sheets having various shapes of pattern units according to embodiments of the present invention;

FIG. 16 is a cross-sectional view for explaining the relationship between the distance between a pair of adjacent pattern units of an external light shield sheet and the height of the pair of adjacent pattern units; and

FIGS. 17 through 20 are cross-sectional views of filters according to embodiments of the present invention.

### DETAILED DESCRIPTION OF THE INVENTION

The present invention will hereinafter be described in detail with reference to the accompanying drawings in which exemplary embodiments of the invention are shown.

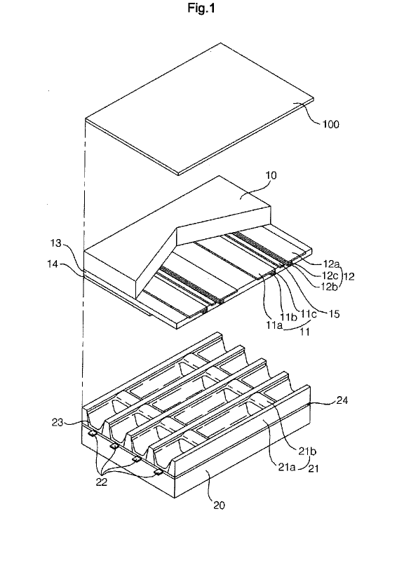

FIG. 1 is a perspective view of a display device according to an embodiment of the present invention. Referring to FIG. 1, a plasma display panel (PDP) includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may be comprised of a stack of chromium/copper/chromium (Cr/Cu/Cr) or a stack of chromium/aluminium/chromium (Cr/Al/Cr). The bus electrodes 11b and 12b are respectively formed on the transparent electrodes 11a and 12a and reduce a voltage drop caused by the transparent electrodes 11a and 12a which have a high resistance.

According to an embodiment of the present invention, each of the electrode pairs may be comprised of the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are formed on the upper substrate 10. The black matrices perform a light shied function by absorbing external light incident upon the upper substrate 10 so that light reflection can be reduced. In addition, the black matrices enhance the purity and contrast of the upper substrate 10.

In detail, the black matrices include a first black matrix 15 which overlaps a plurality of barrier ribs 21, a second black matrix 11c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersects the scan electrode 11 and the sustain electrodes 12. A lower dielectric layer 24 and the barrier ribs 21 are formed on the lower substrate 20 on which the address electrodes 22 are formed.

A phosphor layer 23 is formed on the lower dielectric layer 24 and the barrier ribs 21. The barrier ribs 21 include a plurality of vertical barrier ribs 21a and a plurality of horizontal barrier ribs 21b that form a closed-type barrier rib structure. The barrier ribs 21 define a plurality of discharge cells and prevent ultraviolet (UV) rays and visible rays generated by a discharge from leaking into the discharge cells.

Referring to FIG. 1, a filter 100 is disposed at the front of the PDP. The filter 100 may include an external light shield sheet, an anti-reflection (AR) sheet, a near infrared (NIR) shield sheet, an electromagnetic interference (EMI) shield sheet, a diffusion sheet, and an optical sheet.

When the distance between the filter 100 and the PDP is 10-30 μm, the filter 100 can effectively shield external light incident upon the PDP and can emit light (hereinafter referred to as panel light) generated by the PDP. In order to protect the PDP against external impact such as pressure, the distance between the filter 100 and the PDP may be 30-120 μm. An adhesive layer which can absorb impact may be disposed between the filter 100 and the PDP in order to further protect the PDP against external impact. The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

According to an embodiment of the present embodiment, red (R), green (G), and blue (B) discharge cells are arranged in a straight line. However, the present invention is not restricted to this. For example, R, G, and B discharge cells may be arranged as a triangle or a delta. Alternatively, R, G, and B discharge cells may be arranged as a polygon such as a rectangle, a pentagon, or a hexagon.

The phosphor layer 23 is excited by UV rays that are generated upon a gas discharge. As a result, the phosphor layer 23 generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

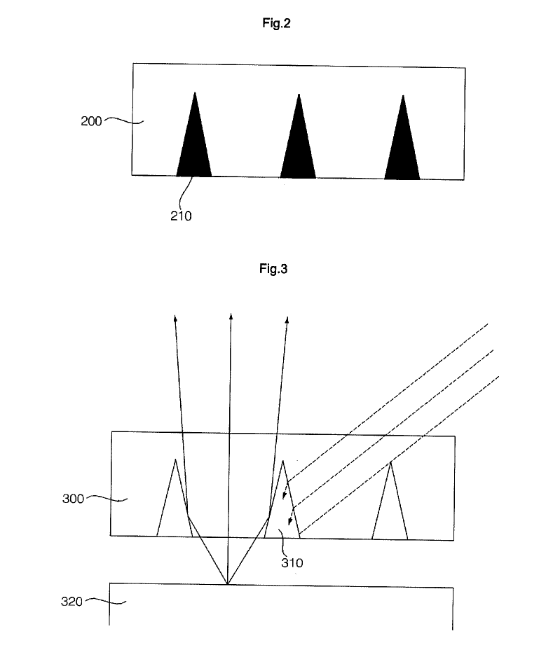

FIG. 2 is a cross-sectional view of an external light shield sheet that can be included in a filter according to an embodiment of the present invention. Referring to FIG. 2, the external light shield sheet includes a base unit 200 and a plurality of pattern units 210.

The base unit 200 may be formed of a transparent plastic material, e.g., a UV-hardened resin-based material, so that light can smoothly transmit therethrough. Alternatively, the base unit 200 may be formed of a rigid material such as glass in order to enhance the protection of an entire surface of a PDP.

Referring to FIG. 2, the pattern units 210 may be triangular, but the present invention is not restricted to this. In other words, the pattern units 210 may be formed in various shapes, other than a triangular shape. The pattern units 210 may be formed of a darker material than the base unit 210. In particular, the pattern units 210 may be formed of a black material. For example, the pattern units 210 may be formed of a carbon-based material or may be dyed black so that the absorption of external light can be maximized. Referring to FIG. 2, the bottom of the external light shield sheet faces toward a PDP, and the top of the external light shield sheet faces toward a viewer. Since an external light source is generally located above a PDP, external light is highly likely to be diagonally incident upon a PDP from above.

In order to absorb and shield such external light and to increase the reflection of panel light through the total-reflection of visual rays emitted from a PDP, the refractive index of the pattern units 210, particularly, the refractive index of the slanted surfaces of the pattern units 210, may be lower than the refractive index of the base unit 200.

Each of the pattern units 210 may contain light absorption particles. The light absorption particles may be stained resin particles. In order to maximize the absorption of light, the light absorption particles may be stained black.

The light absorption particles may have a size of 1 μm or more. In this case, it is possible to facilitate the manufacture of the light absorption particles and the insertion of the light absorption particles into the pattern units 210 and to maximize the absorption of external light. If the light absorption particles have a size of 1 μm or more, each of the pattern units 410 may contain 10 weight % or more of light absorption particles. In this case, it is possible to effectively absorb external light refracted into the pattern units 210.

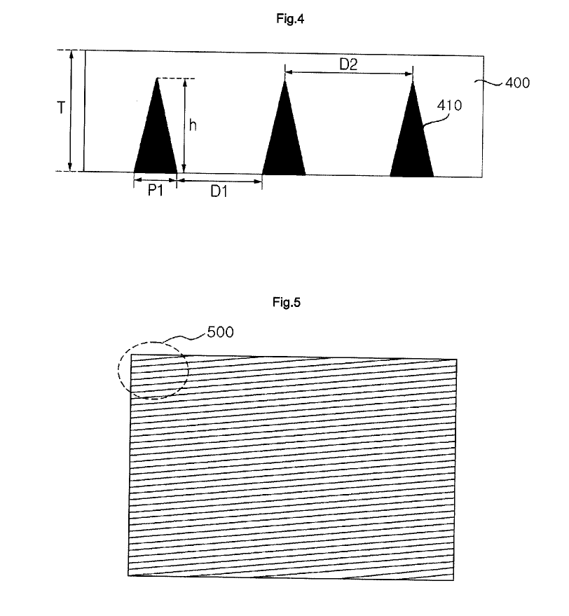

FIG. 3 is a cross-sectional view for explaining an external light shield function and a panel light reflection function of an external light shield sheet according to an embodiment of the present invention. External light which reduces bright room contrast is highly likely to be incident upon a PDP from above. Referring to FIG. 3, according to Snell's law, external light that is diagonally incident upon an external light shield sheet, as indicated by dotted lines, is refracted into and absorbed by a plurality of pattern units 310 which have a lower refractive index than a base unit 300. External light refracted into the pattern units 310 may be absorbed by light absorption particles in the pattern units 310. Panel light for displaying an image is totally reflected toward a viewer by the slanted surfaces of the pattern units 310, as indicated by solid lines. More specifically, since the angle between panel light and the slanted surfaces of the pattern units 310 is greater than the angle between external light and the slanted surfaces of the pattern units 310, external light is refracted into and absorbed by the pattern units 310, whereas panel light is totally reflected by the pattern units 310.

In short, the external light shield sheet illustrated in FIG. 3 can absorb external light so that external light can be prevented from being reflected toward a viewer. In addition, the external light shield sheet illustrated in FIG. 3 can enhance the reflection of panel light so that the bright room contrast of images displayed by a PDP 320 can be increased.

The refractive index of the pattern units 310 may be 0.3-1 times higher than the refractive index of the base unit 300. In this case, it is possible to maximize the absorption of external light and the total reflection of panel light in consideration of the angle at which external light is incident upon the PDP 320. In particular, the refractive index of the pattern units 310 may be 0.3-0.8 times higher than the refractive index of the base unit 300. In this case, it is possible to maximize the total reflection of panel light by the slanted surfaces of the pattern units 310.

When the refractive index of the pattern units 310 is lower than the refractive index of the base unit 300, light emitted from a PDP 320 is reflected by the surfaces of the pattern units 310 and thus spreads out toward the user, thereby resulting in unclear, blurry images, i.e., a ghost phenomenon.

When the refractive index of the pattern units 310 is higher than the refractive index of the base unit 300, external light incident upon the pattern units 310 and light emitted from a PDP 320 are both absorbed by the pattern units 310. Therefore, it is possible to reduce the probability of occurrence of the ghost phenomenon.

In order to absorb as much panel light as possible and thus to prevent the ghost phenomenon, the refractive index of the pattern units 310 may be 0.05 or more higher than the refractive index of the base unit 300.

When the refractive index of the pattern units 310 is higher than the refractive index of the base unit 300, the transmissivity and contrast of an external light shield sheet may decrease. In order not to considerably reduce the transmissivity and contrast of an external light shield sheet while preventing the ghost phenomenon, the refractive index of the pattern units 310 may be 0.05-0.3 higher than the refractive index of the base unit 300. Also, in order to uniformly maintain the contrast of a PDP 320 while preventing the ghost phenomenon, the refractive index of the pattern units 310 may be 1.0-1.3 times greater than the refractive index of the base unit 300.

FIG. 3 illustrates the situation when the bottoms of pattern units 310 faces toward a PDP 320. But the bottoms of pattern units 310 may face toward a user, and the tops of pattern units 310 may face toward a PDP 320. In this case, external light is absorbed by the bottoms of the pattern units 310, thereby enhancing the shielding of external light. The distance between a pair of adjacent pattern units may be widened compared to the distance between a pair of adjacent pattern units. Therefore, it is possible to enhance the aperture ratio of an external light shield sheet.

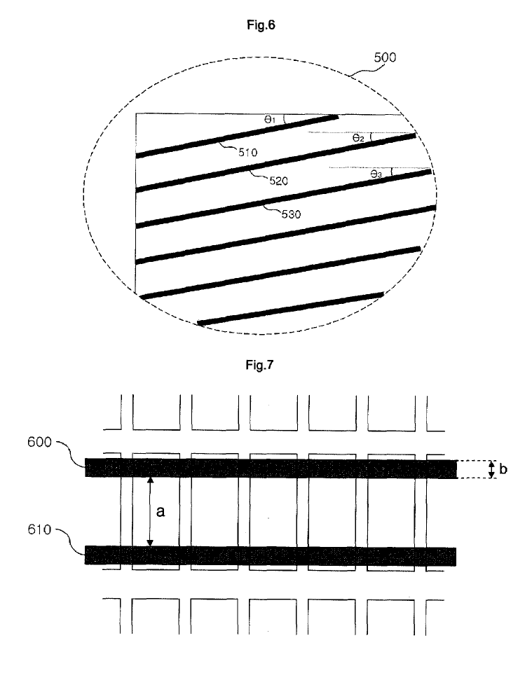

FIG. 4 is a cross-sectional view of an external light shield sheet that can be included in a filter according to an embodiment of the present invention. Referring to FIG. 4, a thickness T of the external light shield sheet may be 20-250 μm. In this case, it is possible to facilitate the manufacture of an external light shield sheet and optimize the transmissivity of an external light shied sheet. In particular, the thickness T may be 100-180 μm. In this case, it is possible to facilitate the transmission of panel light, to effectively absorb and shield external light, and to guarantee the durability of an external light shield sheet.

Referring to FIG. 4, a plurality of pattern units 410 are formed in a base unit 400 as triangles, particularly, equilateral triangles. A bottom width P1 of the pattern units 410 maybe 18-36 μm. In this case, it is possible to secure a sufficient aperture ratio to properly emit light panel light toward a user and maximize the absorption of external light.

A height h of the pattern units 410 may be 80-170 μm. The slopes of the slanted surfaces of the pattern units 410 may be determined in consideration of the bottom width P1 and the height h so that the absorption of external light and the reflection of panel light can be increased, and that the pattern units 410 can be prevented from being short-circuited.

A distance D1 between the bottoms of a pair of adjacent pattern units 410 may be 40-90 μm, and a distance D2 between the tops of the pair of adjacent pattern units 410 may be 90-130 μm. In this case, it is possible to achieve a sufficient aperture ratio to display images with optimum luminance through the emission of panel light toward a user and provide a number of pattern units having slanted surfaces with an optimum slope for enhancing the absorption of external light and the emission of panel light.

The distance D1 maybe 1.1-5 times greater than the bottom width P1. In this case, it is possible to secure an optimum aperture ratio for displaying images. In particular, the distance D1 may be 1.5-3.5 times greater than the bottom width P1. In this case, it is possible to optimize the absorption of external light and the emission of panel light.

The height h may be 0.89-4.25 times greater than the distance D1. In this case, it is possible to prevent external light from being incident upon a PDP. In particular, the height h may be 1.5-3 times greater than the distance D1. In this case, it is possible to prevent the pattern units 410 from being short-circuited and to optimize the reflection of panel light.

The distance D2 may be 1-3.25 times greater than the distance D1. In this case, it is possible to secure a sufficient aperture ratio to display images with optimum luminance. In particular, the distance D2 may be 1.2-2.5 times greater than the distance D1. In this case, it is possible to optimize the total reflection of panel light by the slanted surfaces of the pattern units 410.

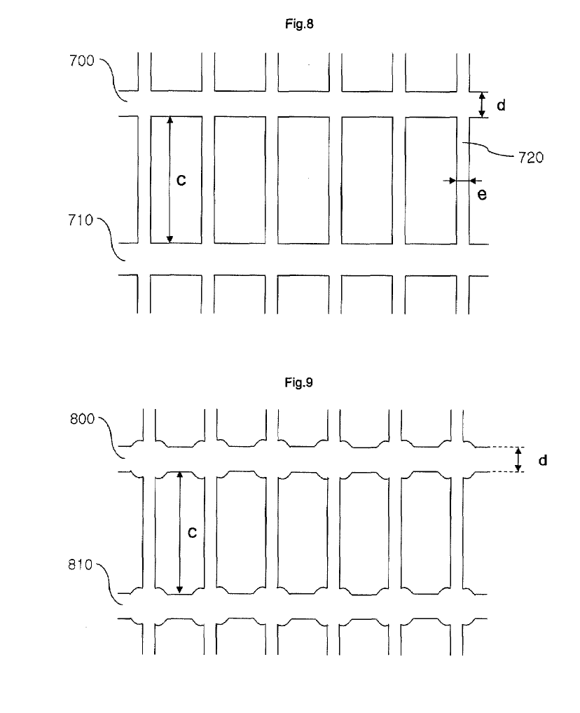

FIGS. 5 and 6 are plan views of a plurality of pattern units of an external light shield sheet according to an embodiment of the present invention. Referring to FIGS. 5 and 6, a plurality of pattern units may be formed in a base unit as stripes, and are a predetermined distance apart from each other.

A moire phenomenon may occur when a plurality of pattern units of an external light shield sheet that are a predetermined distance apart from each other overlap black matrices, a black layer, bus electrodes, and barrier ribs that are formed on a PDP. The moire phenomenon refers to low-frequency patterns that are generated by overlapping similar types of grating patterns. For example, when mosquito nets are overlaid each other, ripple patterns appear.

Referring to FIG. 5, a plurality of pattern units are formed diagonally with respect to the lengthwise direction of an external light shield sheet, thereby reducing the probability of occurrence of the moire phenomenon.

FIG. 6 is an enlarged view of a portion 500 of FIG. 5. Referring to FIG. 6, a plurality of pattern units 510, 520, and 530 are formed diagonally in a direction from a lower right portion of an external light shield sheet to an upper left portion of the external light shield sheet. Alternatively, the pattern units 510, 520, and 530 may be formed diagonally in a direction from an upper left portion of an external light shield sheet to a lower right portion of the external light shield sheet.

Assuming that black matrices, bus electrodes, or horizontal barrier ribs are formed in parallel with the upper boundary of an external light shield sheet, an angle θ₁ between the pattern unit 510 and the upper boundary of the external light shield sheet, an angle θ₂ between the pattern unit 520 and the upper boundary of the external light shield sheet, and an angle θ₃ between the pattern unit 530 and the upper boundary of the external light shield sheet may be 5 degrees or less. In this case, it is possible to reduce the probability of occurrence of the moire phenomenon. In particular, the angles θ₁, θ₂ and θ₃ may be set to be 1.5-3.5 degrees in consideration that an external light source is highly likely to be located above a user's head. In this case, it is possible to prevent the moire phenomenon, to secure an optimum aperture ratio, to increase the reflection of panel light, and to effectively shield external light.

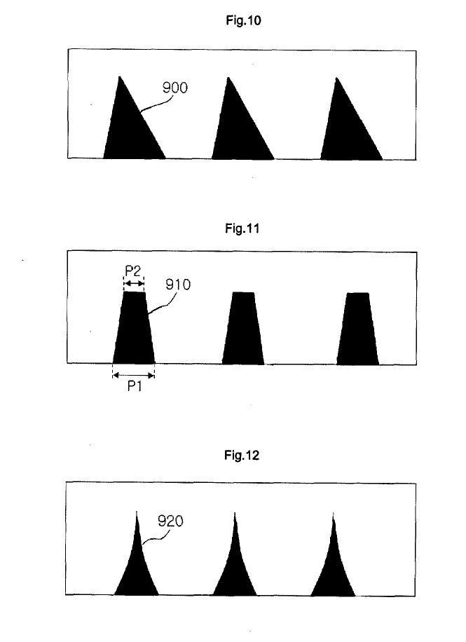

FIG. 7 is a plan view for explaining the structure of bus electrodes that are formed on an upper substrate of a PDP according to an embodiment of the present invention.

As described above with reference to FIG. 4, the distance between a pair of adjacent pattern units of an external light shield sheet may be 40-90 μm. Referring to FIG. 7, a distance a between a pair of adjacent bus electrodes 600 and 610 may be 225-480 μm. In this case, it is possible to reduce a discharge initiation voltage and to secure a sufficient aperture ratio to provide an image with optimum luminance. The distance a may be 2.5-12 times greater than the distance between a pair of adjacent pattern units of an external light shield sheet. In this case, it is possible to secure an optimum aperture ratio of a PDP, maximize the external light shield efficiency of a PDP, and optimize the reflection of panel light.

The distance between a pair of adjacent pattern units of an external light shield sheet may be 40-60 μm, and the distance a may be 225-480 μm. In this case, it is possible to reduce the probability of occurrence of the moire phenomenon. The distance between a pair of adjacent pattern units of an external light shield sheet may be 4-10 times greater than the distance a. In this case, it is possible to secure an optimum aperture ratio of a PDP, maximize the external light shield efficiency of a PDP, optimize the reflection of panel light, and reduce the probability of occurrence of the moire phenomenon.

As described above with reference to FIG. 4, a bottom width of pattern units of an external light shield sheet maybe 18-35 μm, and a width b of the bus electrode 600 may be 45-90 μm, and the bottom width of the pattern units may be 0.2-0.8 times greater than the width b. In this case, it is possible to achieve optimum resistance and capacitance for driving a PDP and secure a sufficient aperture ratio to display an image with optimum luminance.

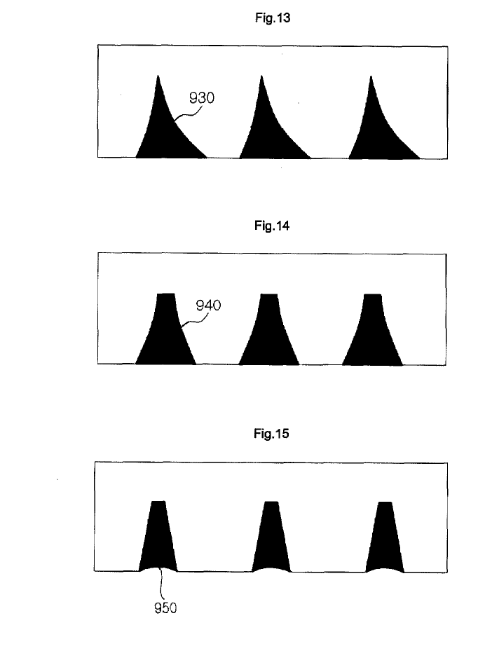

FIGS. 8 and 9 are plan views of various barrier rib structures that can be formed on a lower substrate of a PDP according to an embodiment of the present invention. The barrier rib structure illustrated in FIG. 8 includes a plurality of vertical barrier ribs 720 which intersect a plurality of bus electrodes (not shown) that are formed on an upper substrate (not shown), and a plurality of horizontal barrier ribs 700 and 710 which intersect the vertical barrier ribs 720.

A distance c between the horizontal barrier ribs 700 and 710 may be 540-800 μm. In this case, it is possible to provide an image with optimum luminance and resolution. If the distance between a pair of adjacent pattern units of an external light shield sheet is 40-90 μm, the distance c may be 6-20 times greater than the distance between the pair of adjacent pattern units. In this case, it is possible to secure an optimum aperture ratio of a PDP and increase the external light shield efficiency and the panel light reflection efficiency of a PDP.

If the distance between a pair of adjacent pattern units of an external light shield sheet is 40-60 μm, the distance c may be 600-700 μm. In this case, it is possible to reduce the probability of occurrence of the moire phenomenon. The distance c may be 10-17.5 times greater than the distance between the pair of adjacent pattern units. In this case, it is possible to maximize the absorption of external light, reduce the amount of external light reflected from a PDP, maximize the efficiency of increasing the purity and contrast of an upper substrate, and reduce the probability of occurrence of the moire phenomenon.

When a bottom width of pattern units of an external light shield sheet may be 18-35 μm, as described above with reference to FIG. 4, a width d of the barrier rib 700 may be 45-90 μm. In this case, it is possible to secure a sufficient opening ratio of a PDP to provide an image with optimum luminance. The bottom width of the pattern units may be 0.2-0.8 times greater than the width d. In this case, it is possible to secure a sufficient opening ratio of a PDP to provide an image with optimum luminance and to reduce the probability of occurrence of the moire phenomenon.

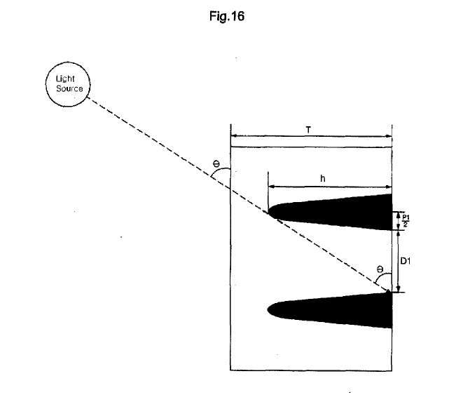

FIGS. 10 through 15 are cross-sectional views of external light shield sheets having various shapes of pattern units according to embodiments of the present invention.

Referring to FIG. 10, a plurality of pattern units 900 may be asymmetrical with respect to their respective horizontal axes. In other words, a pair of slanted surfaces of each of the pattern units 900 may have different areas or may form different angles with the bottom of an external light shield sheet. In other words, a pair of slanted surfaces of each of the pattern units 900 may have different areas or may form different angles with the bottom of a corresponding pattern unit 900. In general, an external light source is located above a PDP. Thus, external light is highly likely to be incident upon a PDP from above at a certain range of angles. One of a pair of slanted surfaces of each of the pattern units 900 upon which external light is directly incident will hereinafter be referred to as an upper slanted surface, and the other slanted surface will hereinafter be referred to as a lower slanted surface. In order to enhance the absorption of external light and the reflection of light emitted from a PDP, the upper slanted surfaces of the pattern units 900 may be less steep than the lower slanted surfaces of the pattern units 900. That is, the slope of the upper slanted surfaces of the pattern units 900 may be less than the slope of the lower slanted surface of the pattern units 900.

Referring to FIG. 11, a plurality of pattern units 910 may be trapezoidal. In this case, a top width P2 of the pattern units 910 is less than a bottom width P1 of the pattern units 910. The top width P2 may be 10 μm or less. The slope of the slanted surfaces of the pattern units 910 can be appropriately determined according to the relationship between the bottom width P1 and the top width P2 so that the absorption of external light and the reflection of light emitted from a PDP can be maximized.

Referring to FIGS. 12 through 14, a pair of slanted surfaces of each of a plurality of pattern units 920, 930, and 940 may have curved lateral surfaces with a predetermined curvature. Each of the pattern units 900, 910, 920, 930, and 940 illustrated in FIGS. 10 through 14 may have curved edges with a predetermined curvature.

Referring to FIG. 15, a plurality of pattern units 950 may have a curved bottom surface with a predetermined curvature.

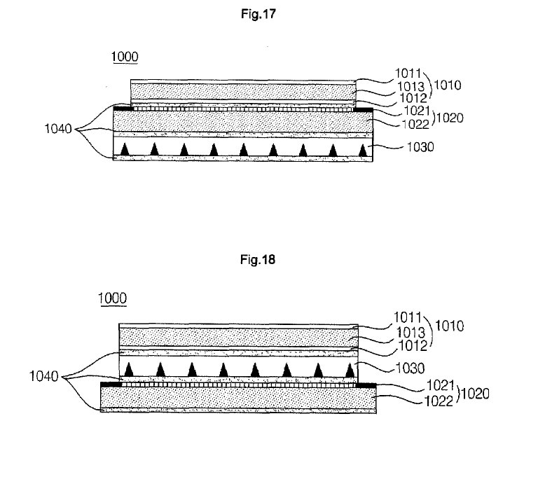

FIG. 16 is a cross-sectional view for explaining the relationship between a thickness T of an external light shield sheet and a height h of a plurality of pattern units of the external light shield sheet.

Referring to FIG. 16, in order to enhance the durability of an external light shield sheet comprising a plurality of pattern units and secure the transmission of visible light emitted from a PDP for displaying images, the thickness T may be set to 100-180 μm. When the height h is within the range of 80-170 μm, the manufacture of an external light shield sheet can be facilitated, an optimum opening ratio can be obtained, and the shielding of external light and the reflection of light emitted from a PDP can be maximized.

The height h can be varied according to the thickness T. In general, external light that considerably affects the bright room contrast of a PDP is highly likely to be incident upon a PDP from above. Therefore, in order to effectively shield external light, the height h may be within a predetermined percentage range of the thickness T.

Referring to FIG. 14, as the height h increases, the thickness of a base unit decreases, and thus, dielectric breakdown is more likely to occur. On the other hand, as the height h decreases, more external light is likely to be incident upon a PDP at a predetermined range of angles, and thus it becomes more difficult for an external light shield sheet to properly shield such external light.

Table 1 presents experimental results obtained by testing a plurality of external light shield sheets having the same thickness T and different pattern unit heights (h) for whether they cause dielectric breakdown and whether they can shield external light.

TABLE 1

| Thickness (T) of | | | |
|---|---|---|---|
| External Light | Height (h) of | Dielectric | External Light |
| Shield sheet | Pattern Units | Breakdown | Shielding |
| 120 μm | 120 μm | ◯ | ◯ |
| 120 μm | 115 μm | Δ | ◯ |
| 120 μm | 110 μm | X | ◯ |
| 120 μm | 105 μm | X | ◯ |
| 120 μm | 100 μm | X | ◯ |
| 120 μm | 95 μm | X | ◯ |
| 120 μm | 90 μm | X | ◯ |
| 120 μm | 85 μm | X | Δ |
| 120 μm | 80 μm | X | Δ |
| 120 μm | 75 μm | X | Δ |
| 120 μm | 70 μm | X | Δ |
| 120 μm | 65 μm | X | Δ |
| 120 μm | 60 μm | X | Δ |
| 120 μm | 55 μm | X | Δ |
| 120 μm | 50 μm | X | X |

Referring to Table 1, when the thickness T is 120 μm and the height h is greater than 115 μm, pattern units of an external light shield sheet are highly likely to dielectrically break down, thereby increasing defect rates. When the height h is less than 115 μm, the pattern units are less likely to dielectrically break down, thereby reducing defect rates. When the height h is less than 85 μm, the external light shielding efficiency of the pattern units is likely to decrease. When the height h is less than 60 μm, external light is likely to be directly incident upon a PDP.

When the thickness T is 1.01-2.25 times greater than the height h, it is possible to prevent the upper portions of the pattern units from dielectrically breaking down and to prevent external light from being incident upon a PDP. In order to prevent dielectric breakdown of the pattern units and infiltration of external light into a PDP, to increase the reflection of light emitted from a PDP, and to secure optimum viewing angles, the thickness T may be 1.01-1.5 times greater than the height h.

Table 2 presents experimental results obtained by testing a plurality of external light shield sheets having different pattern unit bottom width-to-bus electrode width ratios for whether they cause the moire phenomenon and whether they can shield external light, when the width of bus electrodes that are formed on an upper substrate of a PDP is 70 μm.

TABLE 2

| Bottom Width Of | | |
|---|---|---|
| Pattern Units/Width of | | External light |
| Bus Electrodes | Moire | shielding |
| 0.10 | Δ | X |
| 0.15 | Δ | X |
| 0.20 | X | Δ |
| 0.25 | X | ◯ |
| 0.30 | X | ◯ |
| 0.35 | X | ◯ |
| 0.40 | X | ◯ |
| 0.45 | Δ | ◯ |
| 0.50 | Δ | ◯ |
| 0.55 | ◯ | ◯ |
| 0.60 | ◯ | ◯ |

Referring to Table 2, when the bottom width of pattern units is 0.2-0.5 times greater than the width of bus electrodes, the moire phenomenon can be prevented and the amount of external light incident upon a PDP can be reduced. In particular, the bottom width of pattern units may be 0.25-0.4 times greater than the width of bus electrodes. In this case, it is possible to prevent the moire phenomenon, to effectively shield external light, and to secure a sufficient opening ratio to discharge light emitted from a PDP.

Table 3 presents experimental results obtained by testing a plurality of external light shield sheets having different pattern unit bottom width-to-vertical barrier rib width ratios for whether they cause the moire phenomenon and whether they can shield external light, when the width of vertical barrier ribs that are formed on a lower substrate of a PDP is 50

TABLE 3

| Bottom Width of | | |
|---|---|---|
| Pattern Units/Top | | External |
| Width of Vertical | | Light |
| Barrier Ribs | Moire | shielding |
| 0.10 | ◯ | X |
| 0.15 | Δ | X |
| 0.20 | Δ | X |
| 0.25 | Δ | X |
| 0.30 | X | Δ |
| 0.35 | X | Δ |
| 0.40 | X | ◯ |
| 0.45 | X | ◯ |
| 0.50 | X | ◯ |
| 0.55 | X | ◯ |
| 0.60 | X | ◯ |
| 0.65 | X | ◯ |
| 0.70 | Δ | ◯ |
| 0.75 | Δ | ◯ |
| 0.80 | Δ | ◯ |
| 0.85 | ◯ | ◯ |
| 0.90 | ◯ | ◯ |

Referring to Table 3, when the bottom width of pattern units is 0.3-0.8 times greater than the width of vertical barrier ribs, the moire phenomenon can be prevented and the amount of external light incident upon a PDP can be reduced. In particular, the bottom width of pattern units may be 0.4-0.65 times greater than the width of vertical barrier ribs. In this case, it is possible to prevent the moire phenomenon, to effectively shield external light, and to secure a sufficient opening ratio to discharge light emitted from a PDP.

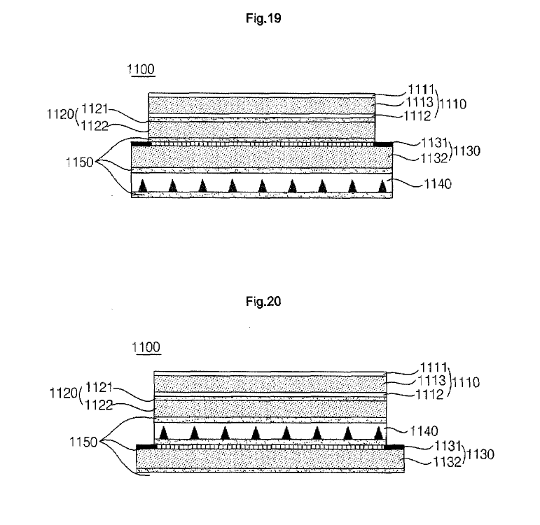

FIGS. 17 through 20 are cross-sectional views of filters according to embodiments of the present invention. According to an embodiment of the present invention, a filter may be disposed at the front of a PDP, and may include an AR/NIR sheet, an EMI shield sheet, an external light shield sheet, and an optical sheet.

Referring to FIGS. 17 and 18, an AR/NIR sheet 1010 includes a base sheet 1013 which is formed of a transparent plastic material; an AR layer 1011 which is attached onto an entire surface of the base sheet 1013 and reduces glare by preventing the reflection of external light incident upon a PDP; and an NIR shield layer 1012 which is attached onto a rear surface of the base sheet 1013 and shields NIR rays emitted from a PDP so that signals provided by a device such as a remote control which transmits signals using infrared rays can be smoothly transmitted.

An EMI shield sheet 1020 includes a base sheet 1022 which is formed of a transparent plastic material and an EMI shield layer 1021 which is attached onto an entire surface of the base sheet 1022 and shields EMI generated by a PDP so that the EMI can be prevented from being released externally. The EMI shield layer 1021 may be formed of a conductive material in a mesh form. In order to properly ground the EMI shield layer 1021, an invalid display zone on the EMI shield sheet 1020 where no images are displayed may be covered with a conductive material.

An external light source is generally located over the head of a user regardless of an indoor or outdoor environment. An external light shield sheet 1030 effectively shields external light so that black images can be rendered even blacker by a PDP.

An adhesive layer 1040 is interposed between the AR/NIR sheet 1010, the EMI shield sheet 1020, and the external light shield sheet 1030 so that the filter 1000 including the AR/NIR sheet 1010, the EMI shield sheet 1020, and the external light shield sheet 1030 can be firmly attached onto a PDP. In order to facilitate the manufacture of the filter 1000, the base sheets 1013 and 1022 may be formed of the same material.

Referring to FIG. 17, the AR/NIR sheet 1010, the EMI shield sheet 1020, and the external light shield sheet 1030 are sequentially deposited. Alternatively, the AR/NIR sheet 1010, the external light shield sheet 1030, and the EMI shield sheet 1020 may be sequentially deposited, as illustrated in FIG. 18. The order in which the AR/NIR sheet 1010, the EMI shield sheet 1020, and the external light shield sheet 1030 are deposited is not restricted to those set forth herein. At least one of the AR/NIR sheet 1010, the EMI shield sheet 1020, and the external light shield sheet 1030 may be optional.

Referring to FIGS. 19 and 20, a filter 1100, which is disposed at the front of a PDP, includes an AR/NIR sheet 1110, an EMI shield sheet 1130, an external light shield sheet 1140, and an optical sheet 1120. The AR/NIR sheet 110, the EMI shield sheet 1130, and the external light shield sheet 1140 are the same as their respective counterparts illustrated in FIGS. 17 and 18. The optical sheet 1120 enhances the color temperature and luminance properties of light incident upon a PDP from above. The optical sheet 1120 includes a base sheet 1122 which is formed of a transparent plastic material, and an optical sheet layer 1121 which is formed of a dye and an adhesive on a front or rear surface of the base sheet 1122.

At least one of the base sheets 1013 and 1022 illustrated in FIGS. 17 and 18 and at least one of a base sheet 1113, a base sheet 1112, and the base sheet 1122 illustrated in FIGS. 19 and 20 may be optional. One of the base sheets 1013 and 1022 illustrated in FIGS. 17 and 18 and one of the base sheets 1113, 1112, and 1122 illustrated in FIGS. 19 and 20 may be formed of such a rigid material as glass, instead of being formed of a plastic material, so that the protection of a PDP can be enhanced. Whichever of the base sheets 1013 and 1022 illustrated in FIGS. 17 and 18 and the base sheets 1113, 1112, and 1122 illustrated in FIGS. 19 and 20 is formed of glass may be a predetermined distance apart from a PDP.

A filter according to an embodiment of the present invention may also include a diffusion sheet. The diffusion sheet can diffuse light incident upon a PDP so that the brightness of the PDP can be uniformly maintained. In addition, the diffusion sheet can widen vertical and horizontal viewing angles of a display screen by uniformly diffusing light emitted from a PDP. Moreover, the diffusion sheet can hide patterns formed on an external light shield sheet. Furthermore, the diffusion sheet can uniformly enhance the front luminance of a PDP through collection of light in a direction corresponding to a vertical viewing angle, and can enhance the antistatic property of a PDP.

The diffusion sheet may be comprised of a transparent or reflective diffusion film. In general, the diffusion sheet may be comprised of a polymer base sheet containing small glass particles. The diffusion sheet may also be comprised of a polymethyl-methacrylate (PMMA) base sheet. In this case, the diffusion sheet is thick and highly heat-resistant and can thus be applied to large-scale display devices which generate a considerable amount of heat.

The plasma display device according to the present invention includes an external light shielding sheet which is disposed at the front of a PDP and which can absorb and shield as much external light incident upon a PDP as possible. Thus, the plasma display device according to the present invention can effectively realize black images and enhance bright room contrast. Since the distance between a pair of adjacent pattern units of an external light shielding sheet is within a predetermined percentage range of the distance between a pair of adjacent black matrices formed on a PDP or the width of pattern units of the external light shielding sheet is a predetermined percentage range of the width of black matrices formed on the PDP, the plasma display device according to the present invention can reduce the probability of occurrence of the moire phenomenon and enhance the luminance of images displayed by a PDP.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device, comprising:
a plasma display panel (PDP) which comprises an upper substrate and a lower substrate that are coupled to each other; and
a filter which is disposed on the upper substrate,
wherein the filter comprises an external light shield sheet which comprises a base unit and a plurality of pattern units that are formed in the base unit, and a distance between bottoms of a pair of adjacent electrodes that are formed on the upper substrate is 2.5-12 times greater than a distance between a pair of adjacent pattern units.

2. The plasma display device of claim 1, wherein the distance between the pair of adjacent electrodes is 4-10 times greater than the distance between the bottoms of the pair of adjacent pattern units.

3. The plasma display device of claim 1, wherein the distance between the pair of adjacent electrodes is 225-480 μm.

4. The plasma display device of claim 1, wherein the distance between the bottoms of the pair of adjacent pattern units is 40-90 μm.

5. The plasma display device of claim 1, wherein a bottom width of the pattern units is 0.2-0.8 times greater than a width of electrodes that are formed on the upper substrate.

6. The plasma display device of claim 1, wherein a refractive index of the pattern units is 0.3-1 times greater than a refractive index of the base unit.

7. The plasma display device of claim 1, wherein a refractive index of the pattern units is higher than a refractive index of the base unit.

8. The plasma display device of claim 1, wherein a refractive index of the pattern units is 1.0-1.3 times higher than a refractive index of the base unit.

9. The plasma display device of claim 1, wherein a thickness of the external light shield sheet is 1.01-2.25 times greater than a height of the pattern units.

10. A plasma display device, comprising:
a PDP which comprises an upper substrate and a lower substrate that are coupled to each other; and
a filter which is disposed on the upper substrate,
wherein the filter comprises an external light shield sheet which comprises a base unit and a plurality of pattern units that are formed in the base unit, the lower substrate comprises a plurality of electrodes and a plurality of horizontal barrier ribs which intersect the electrodes, and a distance between bottoms of a pair of adjacent horizontal barrier ribs is 6-20 times greater than a distance between a pair of adjacent pattern units.

11. The plasma display device of claim 10, wherein the distance between the pair of adjacent horizontal barrier ribs is 10-17.5 times greater than the distance between the bottoms of the pair of adjacent pattern units.

12. The plasma display device of claim 10, wherein the distance between the pair of adjacent horizontal barrier ribs is 540-800 μm.

13. The plasma display device of claim 10, wherein the distance between the pair of adjacent pattern units is 40-90 μm.

14. The plasma display device of claim 10, wherein a bottom width of the pattern units is 0.2-0.8 times greater than a top width of the horizontal barrier ribs.

15. The plasma display device of claim 10, wherein the lower substrate further comprises a plurality of vertical barrier ribs which intersect the horizontal barrier ribs, and a bottom width of the pattern units is 0.3-0.8 times greater than a top width of the vertical barrier ribs.

16. The plasma display device of claim 10, wherein a refractive index of the pattern units is 0.3-1 times greater than a refractive index of the base unit.

17. The plasma display device of claim 10, wherein a refractive index of the pattern units is higher than a refractive index of the base unit.

18. The plasma display device of claim 10, wherein a refractive index of the pattern units is 1.0-1.3 times higher than a refractive index of the base unit.

19. A filter, comprising:
an external light shield sheet which comprises a base unit and a plurality of pattern units that are formed in the base unit,
wherein a distance between bottoms of a pair of adjacent electrodes that are formed on an upper substrate of a display panel is 2.5-12 times greater than a distance between a pair of adjacent pattern units.

20. A filter, comprising:
an external light shield sheet which comprises a base unit and a plurality of pattern units that are formed in the base unit,
wherein a distance between a pair of adjacent horizontal barrier ribs that are formed on a display panel is 6-20 times greater than a distance between bottoms of a pair of adjacent pattern units.
